(19) United States
(12) Patent Application Publication
(10) Pub. No.: US 2014/0156436 A1
(43) Pub. Date: Jun. 5, 2014

(54) System and Method for Product Deployment and Management

(71) Applicant: BANK OF AMERICA CORPORATION, Charlotte, NC (US)

(72) Inventors: Kerry E. McClennen, Charlotte, NC (US); Brent B. Allen, Charlotte, NC (US); William D. Peterson, St. Augustine, FL (US); Matthew C. Steed, Charlotte, NC (US); Randall G. Steiner, Meridian, ID (US)

(73) Assignee: Bank of America Corporation, Charlotte, NC (US)

(21) Appl. No.: 13/692,018

(22) Filed: Dec. 3, 2012

(51) Int. Cl. G06Q 30/06

(52) U.S. Cl. CPC G06Q 30/0601
USPC 705/26.1

(57) ABSTRACT

A system may include a memory and a processor. The processor is operable to create a product definition associated with a product, associate a first schedule with the product definition, and associate a second schedule with the product definition. The processor is also operable to determine a first price for the product and present the first price to a customer. The processor may be further operable to receive an indication that the customer has accepted the first price and associate the first price with the customer in response to receiving the indication. Finally, the processor is operable to determine a charge associated with the customer and initiate the billing of the customer for the charge.

### TECHNICAL FIELD OF THE INVENTION

This disclosure relates generally to a system for the deployment and management of products offered for sale.

### BACKGROUND OF THE INVENTION

As enterprises increase the quantity of goods and services for sale to customers, the complexity of conducting transactions for those goods and services also increases. Enterprises may desire to manage various aspects of the purchase of these goods and services.

### SUMMARY OF THE INVENTION

According to embodiments of the present disclosure, disadvantages, and problems associated with previous product deployment and management systems may be reduced or eliminated.

In certain embodiments, a system may include a memory and a processor. The processor is operable to create a product definition associated with a product, associate a first schedule with the product definition, and associate a second schedule with the product definition. The processor is also operable to determine a first price for the product and present the first price to a customer. The processor may be further operable to receive an indication that the customer has accepted the first price and associate the first price with the customer in response to receiving the indication. Finally, the processor is operable to determine a charge associated with the customer and initiate the billing of the customer for the charge.

Particular embodiments of the present disclosure may provide some, none, or all of the following technical advantages. For example, in certain embodiments, a product deployment and management system can be utilized to define a variety of products at a large scale, thereby reducing the computational resources, bandwidth, and number of components consumed by older systems which lacked the flexibility to deploy and manage products according to the present disclosure. Another advantage is, in certain embodiments, the product deployment and management system may be used to define multiple terms and conditions for the same product, thereby reducing the computational resources, bandwidth, and number of components required for previous systems. Additionally, in certain embodiments, the product deployment and management system is flexible enough to detect out of date contract terms and conditions for particular products and facilitate the updating of the contracts, thereby reducing the bandwidth, computational resources, and personnel hours required to attempt to fix contract errors in previous systems while improving customer satisfaction with improved pricing accuracy.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example product deployment and management system;

FIG. 2A illustrates example product data which may be used by the example system of FIG. 1;

FIG. 2B illustrates example fee schedule data which may be used by the example system of FIG. 1;

FIG. 2C illustrates example contract data which may be used by the example system of FIG. 1; and

FIG. 3 illustrates an example method for product deployment and management, which may be performed by the example system of FIG. 1 according to certain embodiments of the present disclosure.

### DETAILED DESCRIPTION OF THE INVENTION

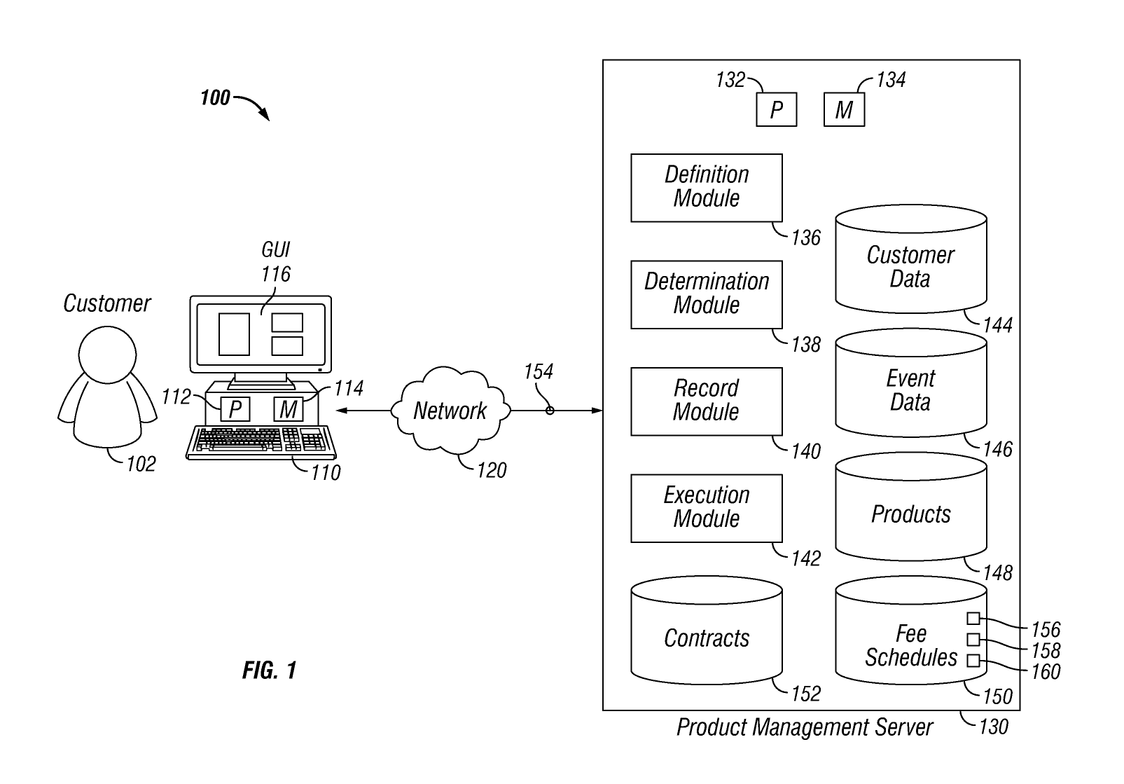

Certain embodiments of the present disclosure provide techniques for deploying and managing products. FIGS. 1 through 3 below illustrate systems and methods for product deployment and management.

FIG. 1 illustrates an example product deployment and management system. In general, enterprises, such as financial institutions, may offer various goods and services for sale to a customer. The enterprise may define various aspects of those goods and services including the terms associated with the purchase of a particular good and service. Certain goods and services may have conditional terms for purchase of the good or service that are based on variables such as customer information or the occurrence of certain events. Enterprises may offer the defined good or service for sale to a customer by determining the best price of the good or service based on available data. Once a customer agrees to the purchase of a good or service, the enterprise may record the terms and conditions of the purchase. After the customer agrees to the transaction, the enterprise may execute the transaction by billing the customer for the good or service according to the agreed terms and conditions of the purchase contract.

In particular, product deployment and management system 100 comprises customer 102, computer 110, network 120, and product management server 130. Customer 102 may be any customer that intends to purchase a particular good or service (e.g., product 148, discussed below) offered for sale by the enterprise. For example, customer 102 may use computer 110 to purchase a particular product 148. Computer 110 may be any device capable of providing functionality to, being operable for a particular purpose, or otherwise used by customer 102 to access particular functionality of product deployment and management system 100. Computer 110 may be operable to communicate with network 120, product management server 130, and/or any other component of product deployment and management system 100. For example, computer 110 may be a laptop computer, desktop computer, terminal, kiosk, personal digital assistant (PDA), cellular phone, tablet, portable media player, smart device, smart phone, or any other device capable of electronic communication.

In certain embodiments computer 110 used by customer 102 may include one or more processors 112, one or more memories 114, one or more displays, one or more interfaces, one or more components capable of inputting data, one or more components capable of outputting data, one or more components capable of communicating with any other component of product deployment and management system 100, or any other component suitable for a particular purpose. Communication may be accomplished wirelessly or via wireline and may be in the form of an e-mail, SMS text message, an instant message, a packet according to a network protocol, and/or any other suitable message format. According to certain embodiments, computer 110 may include a unique device identifier that differentiates computer 110 from any other computer 110 in the example system.

In some embodiments, computer 110 also may comprise graphical user interface (GUI) 116. GUI 116 is generally operable to tailor and filter data presented to customer 102. GUI 116 may provide customer 102 with an efficient and user-friendly presentation of information regarding the functionality of computer 110. GUI 116 may comprise a plurality of displays having interactive fields, pull-down lists, and buttons operated by customer 102. GUI 116 may include multiple levels of abstraction including groups and boundaries. In certain embodiments, GUI 116 may comprise a web browser. In another embodiment, GUI 116 may comprise a graphical representation of a mobile application.

At certain times, computer 110 may attempt to communicate with product management server 130 over network 120. Network 120 facilitates wireless or wireline communication. Network 120 may communicate, for example, IP packets, Frame Relay frames, Asynchronous Transfer Mode (ATM) cells, voice, video, data, and other suitable information between network addresses. Network 120 may include one or more personal area networks (PANs), local area networks (LANs), a wireless LAN (WLAN), a virtual private network (VPN), radio access networks (RANs), metropolitan area networks (MANs), wide area networks (WANs), mobile networks (e.g., using WiMax (802.16), WiFi (802.11), 3G, 4G, or any other suitable wireless technologies in any suitable combination), all or a portion of the global computer network known as the Internet, an extranet, a satellite network, and/or any other communication system or systems at one or more locations, any of which may be any suitable combination of wireless and wireline.

Generally, customer 102 may use network 120 to access offers for sale of products 148 by the enterprise. For example, a financial institution may allow customer 102 to conduct a financial transaction via a website using a computing device for a particular product 148. These products 148 may include any suitable combination of computer services (e.g., storage, computer processing, networking, applications, power, or any other suitable computing resource that may be made available over a network), financial goods and services (e.g., credit cards, certificates of deposit (CD), individual retirement accounts (IRA), safe deposit boxes, mortgages, brokerage services, loans, account access, automated teller machine service, checking accounts, savings accounts, wire transfers, or any other good or service that may be offered for sale), and/or retail services (e.g., purchase and/or sale of goods and services or any other suitable retail service that may be available over a network). In certain embodiments, products 148 may be any good or service with a contract between customer 102 and the enterprise that may be maintained.

Products 148 may be deployed and managed by product management server 130. For example, before offering a particular product 148 for sale to customer 102, an employee of the enterprise may use product management server 130 to define various details (e.g., pricing) regarding product 148. Once the particular product 148 is defined, product management server 130 may facilitate the offer for sale of the particular product 148 to customer 102. Product management server 130 may also record accepted offers for sale as well as execute transactions.

More specifically, product management server 130 may comprise processor 132, memory 134, definition module 136, determination module 138, record module 142, customer data 144, event data 146, products 148, fee schedules 150, and contracts 152. Processor 132 may include one or more microprocessors, controllers, or any other suitable computing devices or resources. Processor 132 may work, either alone or with components of product deployment and management system 100, to provide a portion or all of the functionality of product deployment and management system 100 described herein. For example, in some embodiments, processor 132 may provide functionality for definition module 136, determination module 138, record module 140, and/or execution module 142. Processor 132 communicatively couples to memory 134. Memory 134 may take the form of volatile or non-volatile memory including, without limitation, magnetic media, optical media, RAM, ROM, removable media, or any other suitable memory component. In certain embodiments, a portion or all of memory 134 may store one or more database data structures, such as one or more structured query language (SQL) servers or relational databases.

In certain embodiments, memory 134 may be internal or external to processor 132 and may include one or more instruction caches or one or more data caches. Instructions in the instruction caches may be copies of instructions in memory 134, and the instruction caches may speed up retrieval of those instructions by processor 132. Data in the data caches may include any suitable combination of copies of data in memory 134 for instructions executing at processor 132 to operate on, the results of previous instructions executed at processor 132 for access by subsequent instructions executing at processor 132, or for writing to memory 134, and/or any other suitable data. The data caches may speed up read or write operations by processor 132.

Product management server 130 may include definition module 136. Definition module 136 may be used to facilitate the creation of a particular product 148. Definition module 136 may be any software, hardware, firmware, or combination thereof capable of facilitating the creation of a particular product 148. For example, definition module 136 may be used to define the name, type, and/or price associated with a particular product 148. Once defined, a particular product 148 may be stored as part of products 148. In certain embodiments, a particular product 148 may be assigned a unique product identifier to differentiate the particular product 148 from another product 148. According to some embodiments, products 148 may be stored in one or more text files, tables in a relational database, or any other suitable data structure capable of storing information.

Definition module 136 may also be used to define a price of a product 148. The price of a particular product 148 may be a fixed price or it may be a variable price based on a variety of factors. In certain embodiments, definition module 136 may be used to define the price of a particular product 148 by associating one or more fee schedules 150 with the particular product 148. The association of the one or more fee schedules 150 with a particular product 148 may be stored as part of products 148, fee schedules 150, or any other component of product management server 130 suitable for a particular purpose. A fee schedule 150 is simply a charge, payment, credit, or benefit that may be associated with one or more products 148. According to some embodiments, fee schedules 150 may be stored in one or more text files, tables in a relational database, or any other suitable data structure capable of storing information. Information that may be stored for a particular fee schedule 150 may be a unique schedule identifier, a schedule name, a schedule type, schedule details, and/or any other information that may be suitable for defining a particular fee schedule 150.

More than one fee schedule 150 may be associated with a particular product 148. Certain fee schedules 150 associated with a particular product 148 may be considered “default” or “base” charges for a particular product 148. In some embodiments, definition module 136 may be used to assign a priority rating to a fee schedule 150 indicating that the fee schedule 150 should be chosen to determine a price over another fee schedule 150. Certain fee schedules 150 associated with a particular product 148 may be conditional charges for a particular product 148 that may be based, at least in part, on one or more factors. Such factors may include the identity of customer 102, the employment status of customer 102, the geographic location of customer 102, the age of customer 102, the assets of customer 102, the channel (e.g., online, a particular store location, etc.) for a particular transaction, other products 148 associated with customer 102, or any other suitable factor that may affect the price of a particular product 148. Product deployment and management system 100 is capable of handling any combination of “default” fee schedules 150 and/or conditional fee schedules 150 that may be associated with a particular product 148 suitable for any particular purpose. In some embodiments, fee schedule 150 may be one of at least three types:

rate schedule 156, maintenance fee schedule 158, or ancillary fee schedule 160. Rate schedule 156 may be a charge or a payment for a good or service with reference to some basis of calculation. For example, rate schedule 156 may be either a charge related to product 148 to customer 102 or it may be a payment related to product 148 made to customer 102. According to some embodiments, rate schedule 156 may be a percentage applied to a sum of money for a particular period of time. Some examples of rate schedules 156 may be interest rates for CDs, loans, credit cards, savings accounts, checking accounts, investment accounts, or any other suitable product 148.

A second possible type of fee schedule 150 is maintenance fee schedule 158. Maintenance fee schedule 158 may be any periodic charge by an enterprise for the use of a good or service by customer 102. For example, maintenance fee schedule 158 may be a monthly charge related to maintaining an account, a credit card, a debit card, a safety deposit box, or any other suitable product 148.

A third possible type of fee schedule 150 is ancillary fee schedule 160. Ancillary fee schedule 160 may be any charge that is initiated on a per-use basis. For example, ancillary fee schedule 160 may be a stop payment fee, a wire transfer fee, an ATM fee, a checkbook reorder fee, a transaction fee, or any other charge that may be associated with a particular product 148.

According to some embodiments, rate schedules 156, maintenance fee schedules 158, and ancillary fee schedules 160 may be stored in one or more text files, tables in a relational database, or any other suitable data structure capable of storing information. Information that may be stored may be a unique schedule identifier, a schedule name, schedule details, and/or any other information that may be suitable for defining a particular rate schedule 156, maintenance fee schedule 158, or ancillary fee schedule 160. In certain embodiments, rate schedules 156, maintenance fee schedules 158, and ancillary fee schedules 160 may each be stored in separate tables in a relational database. In other embodiments, rate schedules 156, maintenance fee schedules 158, and ancillary fee schedules 160 may be stored in the same table in a relational database. According to some embodiments, fee schedules 150 may include pointers to the data structure storing a particular rate schedule 156, maintenance fee schedule 158, or ancillary fee schedule 160.

Once a particular product 148 has been defined, the particular product 148 may be offered for sale to a customer 102. Product management server 130 may include determination module 138 which may determine a price to quote for an offer for sale of a particular product 148 to a particular customer 102. Generally, determination module 138 may determine the price of the particular product 148 based at least in part on fee schedules 150, data associated with customer 102, or any other information suitable for a particular purpose. More specifically, determination module 138 may be any software, hardware, firmware, or combination thereof capable of determining a price of a particular product 148. Determination module 138 may access fee schedules 150 associated with a particular product 148, customer data 144 associated with a particular customer 102, event data 146, or any other information suitable for determining one or more prices associated with a particular product 148.

Product management server 130 may include customer data 144 that may be used by determination module 138 or any other suitable component of product management server 130. Generally, customer data 144 contains information about customers 102 that may purchase a good or service from an enterprise. In particular, customer data 144 may include data associated with one or more customers 102. Customer data 144 may contain information such as unique customer identifier, customer name, user credentials, customer address, email address, customer preferences, payment information, credit agency/score, geography data associated with a customer 102, and/or any other information useful for monitoring and purchasing goods and services as appropriate. In certain embodiments, customer data 144 may be stored in one or more text files, tables in a relational database, or any other suitable data structure capable of storing information.

Product management server 130 may also include event data 146. Generally, event data 146 may be data associated with any particular event that may affect the price of a transaction for a particular good or service. In particular, event data 146 may contain information regarding one or more events. Event data 146 may include a change in the status of customer 102 such as an age change, an asset level change, a usage or activity level, an employment status change, change in the relationship between a customer 102 and the enterprise, or any other status change associated with a particular customer 102 that may affect a particular transaction suitable for any particular purpose. Event data 146 may also include the time of a potential transaction, the channel of a potential transaction, the geography information associated with a potential transaction, or any other detail associated with a particular transaction or offer for sale as appropriate. Example channels that may be stored as part of event data 146 are online channels, brick and mortar channels, particular store locations, particular geographical locations, or any other data associated with a particular means for a customer 102 of interacting with a particular offer for sale suitable for any particular purpose. In certain embodiments, event data 146 may be stored in one or more text files, tables in a relational database, or any other suitable data structure capable of storing information.

Determination module 138 is capable of determining the price of a particular product 148 by accessing one or more fee schedules 150, customer data 144, and/or event data 146. Using accessed data, determination module 138 may determine a price for a particular product 148. For example, determination module 138 may determine which fee schedules 150 are associated with a particular product 148. Based on the appropriate one or more fee schedules 150 associated with a particular product 148, customer data 144, and/or event data 146, determination module 138 may calculate a price associated with a particular product 148.

In certain embodiments, more than one fee schedule 150 may apply to a particular product 148. In such embodiments, determination module 138 is capable of determining the appropriate price associated with a particular product 148 to offer to customer 102 based on at least one fee schedule 150. For example, determination module 138 may use customer data 144 or event data 146 or any other suitable information to determine a particular fee schedule 150 should apply to a particular product 148 instead of a different fee schedule 150.

After determining a proposed price for a particular product 148, product management server 130 may facilitate the communication of the proposed price for the particular product 148 to customer 102. For example, product management server 130 may generate message 154 which may include information about the proposed price for a particular product 148. Product management server 130 may communicate message 154 to computer 110 over network 120. The proposed price for a particular product 148 may then be displayed on computer 110 to customer 102. For example, the proposed price for particular product 148 may be displayed using the GUI 116 of computer 110.

Product management server 130 may also include record module 140. Record module 140 may be used to facilitate the recording of information associated with an accepted offer for sale for a particular product 148 by a particular customer 102. Record module 140 may be any software, hardware, firmware, or combination thereof capable of facilitating the recording of information regarding an offer for sale for a particular product 148. For example, record module 140 may store details for an accepted offer for sale in contracts 152. In certain embodiments, record module 140 may store details for an accepted offer for sale in contracts 152 in response to receiving an indication that customer 102 has accepted a proposed price for a contract 152. Contracts 152 may store any information associated with an accepted offer for sale for a particular product 148 by a customer 102. Contracts 152 may include information associated with an accepted offer for sale such as a contract identifier, information associated with customer 102, information associated with a particular product 148, information associated with one or more fee schedules 150, such as rate schedule 156, maintenance fee schedule 158, and/or ancillary fee schedule 160 or any other information that may be associated with a particular accepted offer for sale. In certain embodiment, contracts 152 may be stored in ore or more text files, tables, and a relational database or any other suitable data structure capable of storing information.

Record module 140 is also capable of determining whether any contract 152 may be eligible for an update. For example, a change in customer data 144, event data 146, products 148 and/or fee schedules 150 may cause a price for an accepted offer for sale to change. Examples of when a price for contract 152 may change may include a change in age of customer 102, change in assets for customer 102, the change in employment for customer 102, the change in location for customer 102, change in the relationship of customer 102 to the enterprise, or any other change that will alter which particular fee schedules 150 may apply to a particular product 148 for customer 102.

In response to record module 140 determining that contract 152 may be updated, product management server 130 may facilitate the communication of an updated offer for sale to customer 102 by communicating message 154 over network 120 to computer 110. Message 154 may include an updated price associated with a particular product 148. Once customer 102 accepts the updated offer for sale, record module 140 may update the particular contract 152 associated with the offer for sale.

Product management server 130 may also include execution module 142. Generally, execution module 142 is capable of finalizing the price associated with a particular contract 152 while determining whether terms and conditions associated with a particular contract 152 are being met and/or whether or not to execute a particular contract 152. More specifically, execution module 142 may be any software, hardware, firmware, or combination thereof capable of analyzing and executing a particular contract 152. For example, execution module 142 may retrieve information stored in contracts 152, fee schedules 150, products 148, event data 146, customer data 144, and/or any other suitable information and determine whether a payment or charge to a customer 102 may be adjusted based at least in part upon certain pricing conditions being met. In response to determining a price for a particular contract 152 is accurate (e.g., the price should not be adjusted or already has been adjusted), execution module 142 may make the determination that contract 152 should be executed. Execution module 142 may execute a particular contract 152 by initiating a charge or payment to a customer 102 according to the terms and conditions for the particular contract 152.

In certain instances, execution module 142 may determine that the price associated with contract 152 may be adjusted and thus, a particular contract 152 should not be executed. An example of such an instance would be a change in customer data 144 or a change in event data 146 that would affect the applicability of one or more fee schedules 150 to a product 148. As another example, a particular fee schedule 150 associated with a particular product 148 may have a usage limit for a particular price. Exceeding the usage limit may cause the price to be adjusted.

In response to execution module 142 determining that contract 152 price may be adjusted, product management server 130 may facilitate the updating of a particular contract 152 and communicating the updated contract 152 to customer 102. For example, product management server 130 may communicate the updated terms associated with a particular contract 152 to computer 110 via message 154 over network 120. Once the updated terms of a particular contract 152 are accepted by customer 102, the updated terms may be stored in contracts 152 and executed.

The operation of product deployment and management system 100 will now be discussed. Generally, an enterprise may utilize product management server 130 to define a particular product 148. Defining a particular product 148 may include defining more than one price associated with a particular product 148, where some prices may be conditional based on certain factors. Product management server 130 may determine the appropriate price for a particular product 148 to quote to customer 102. For example, the appropriate price may be chosen because it is the lower price. Once customer 102 accepts a price quote for a particular product 148, product management server 130 may record the contract between customer 102 and the enterprise for that price quote for the particular product 148. Finally, product management server 130 may also execute the contract between customer 102 and the enterprise for the particular product 148.

More specifically, an enterprise may use definition module 136 of product management server 130 to define one or more products 148. For example, definition module 136 may be used to create a particular product 148. Creating a particular product 148 may include defining various details associated with a particular product 148 such as assigning a product identifier, a product name, and any other suitable details associated with product 148. Additionally, defining a product 148 may also include associating one or more fee schedules 150 with the particular product 148. For example, definition module 136 may be used to associate one or more rate schedules 156 with a particular product 148. In certain embodiments, a first rate schedule 156 may be associated with product 148 based on particular customer data 144, particular event data 146, or any other information that may affect a price of a product 148. Associated rate schedules 156 may be stored as part of products 148, contracts 152, fee schedules 150, or in any other component of product management server 130 suitable for a particular purpose. Definition module 136 may be used to associate a second rate schedule 156 with the particular product 148. The second rate schedule 156 may be based on particular customer data 144, particular event data 146, or any other information that may affect the price of a particular product 148.

Definition module 136 may be used to associate one or more maintenance fee schedules 158 with a particular product 148. In certain embodiments, a first maintenance fee schedule 158 may be associated with product 148 based on particular customer data 144, particular event data 146, or any other information that may affect a price of a product 148. Associated maintenance fee schedules 158 may be stored as part of products 148, contracts 152, fee schedules 150, or in any other component of product management server 130 suitable for a particular purpose. Definition module 136 may be used to associate a second maintenance fee schedule 158 with the particular product 148. The second maintenance fee schedule 158 may be based on particular customer data 144, particular event data 146, or any other information that may affect the price of a particular product 148.

Definition module 136 may also be used to associate one or more ancillary fee schedules 160 with a particular product 148. In certain embodiments, a first ancillary fee schedule 160 may be associated with product 148 based on particular customer data 144, particular event data 146, or any other information that may affect a price of a product 148. Associated ancillary fee schedules 160 may be stored as part of products 148, contracts 152, fee schedules 150, or in any other component of product management server 130 suitable for a particular purpose. Definition module 136 may be used to associate a second ancillary fee schedule 160 with the particular product 148. The second ancillary fee schedule 160 may be based on particular customer data 144, particular event data 146, or any other information that may affect the price of a particular product 148.

The operation of determining a price for a particular product 148 to offer to a customer 102 will now be discussed. Product deployment and management system 100 may determine a price for a product 148 by utilizing determination module 138. Determination module 138 may determine the price of a product 148 by accessing information from products 148, customer data 144, event data 146, fee schedules 150 or any other data that may affect a price of a particular product 148. Determination module 138 may determine if there is a particular rate schedule 156 associated with the particular product 148. In certain embodiments, there may be one or more rate schedules 156 associated with the particular product 148. In such an embodiment, determination module 138 may utilize customer data 144, event data 146, or any other information associated with customer 102 to determine the appropriate rate schedule 156 for the particular product 148.

Additionally, determination module 138 may determine if there is a particular maintenance fee schedule 158 associated with the particular product 148. In certain embodiments, there may be one or more maintenance fee schedules 158 associated with the particular product 148. In such an embodiment, determination module 138 may utilize customer data 144, event data 146, or any other information associated with customer 102 to determine the appropriate maintenance fee schedule 158 for the particular product 148.

Determination module 138 may also determine if there is a particular ancillary fee schedule 160 associated with the particular product 148. In certain embodiments, there may be one or more ancillary fee schedules 160 associated with the particular product 148. In such an embodiment, determination module 138 may utilize customer data 144, event data 146, or any other information associated with customer 102 to determine the appropriate ancillary fee schedule 160 for the particular product 148. Using the accessed date, determination module 138 may then calculate the price to offer to customer 102.

Once determination module 138 has determined an appropriate price for a particular product 148, product management server 130 may present that price to customer 102. For example, product management server 130 may communicate message 154 over network 120 to computer 110. Message 154 may comprise details about products 148, the determined price for the particular product 148, or any other information suitable for presenting a particular product 148 for sale to customer 102. In response to receiving message 154, computer 110 may present the quoted price of a particular product 148 to customer 102. Computer 110 may do this by presenting the price and/or details associated with the product 148 in GUI 116 of computer 110.

In response to being presented a price quote for a particular product 148, customer 102 may accept the presented price quote for the particular product 148. Customer 102 may indicate acceptance of the price quote for product 148 by interacting with computer 110. In response to customer 102 indicating to computer 110 that the quoted price for product 148 is accepted, computer 110 may communicate message 154 over network 120 to product management server 130. Message 154 may include an indication that customer 102 has accepted the quoted price for a particular product 148.

After customer 102 has indicated acceptance of a quoted price record module 140 may store details for an accepted offer for sale in contracts 152. Record module 140 may store any information associated with an accepted offer for sale for a particular product 148 by a customer 102 in contracts 152. Record module 140 may store, in contracts 152, information associated with an accepted offer for sale such as a contract identifier, information associated with customer 102, information associated with a particular product 148, information associated with one or more fee schedules 150, such as rate schedule 156, maintenance fee schedule 158, and/or ancillary fee schedule 160 or any other information that may be associated with a particular accepted offer for sale.

Record module 140 may also determine whether any contract 152 is out of date. For example, a change in customer data 144, event data 146, products 148 and/or fee schedules 150 may cause a price for an accepted offer for sale to change. In response to record module 140 determining that contract 152 may be updated, product management server 130 may facilitate the updating of the terms and conditions associated with a particular contract 152.

After updating terms and conditions associated with a particular contract 152, product management server 130 may facilitate the communication of an updated offer for sale to customer 102 by communicating message 154 over network 120 to computer 110. Message 154 may include an updated price associated with a particular product 148. Once customer 102 accepts the updated offer for sale, record module 140 may update the particular contract 152 associated with the offer for sale.

When it is time for a particular contract 152 to be executed (e.g., on a specific date or after a certain period of time), execution module 142 may retrieve information stored in contracts 152, fee schedules 150, products 148, event data 146, customer data 144, and/or any other suitable information. In response to determining that the price for a particular contract 152 should not be adjusted or already has been adjusted (e.g., based on which pricing conditions were met), execution module 142 may make the determination that contract 152 should be executed and may initiate the billing of or payment to customer 102.

Any component of product deployment and management system 100 may include an interface (e.g., network interface), logic, memory, and other suitable elements. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of product deployment and management system 100.

Certain embodiments of the present disclosure may provide some, none, or all of the following technical advantages. For example, in certain embodiments, product deployment and management system 100 can be utilized to define a variety of products at a large scale, thereby reducing the computational resources, bandwidth, and number of components consumed by older systems which lacked the flexibility to deploy and manage products according to the present disclosure. Another advantage is, in certain embodiments, product deployment and management system 100 may be used to define multiple terms and conditions for the same product, thereby reducing the computational resources, bandwidth, and number of components required for previous systems. Additionally, in certain embodiments, product deployment and management system 100 is flexible enough to detect out of date contract terms and conditions for particular products and facilitate the updating of the contracts, thereby reducing the bandwidth, computational resources, and personnel hours required to attempt to fix contract errors in previous systems.

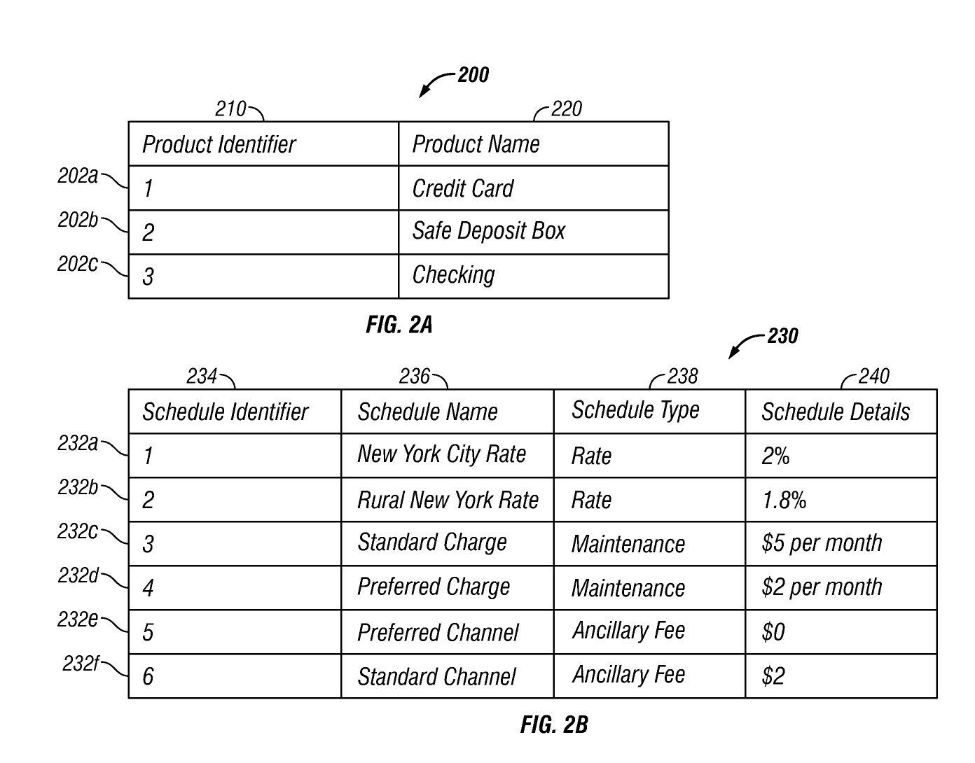

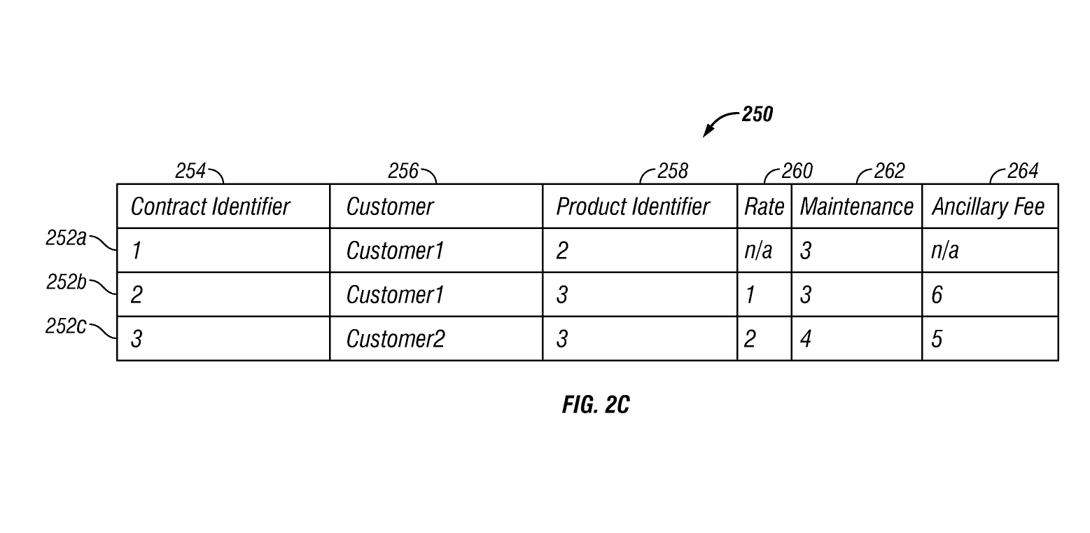

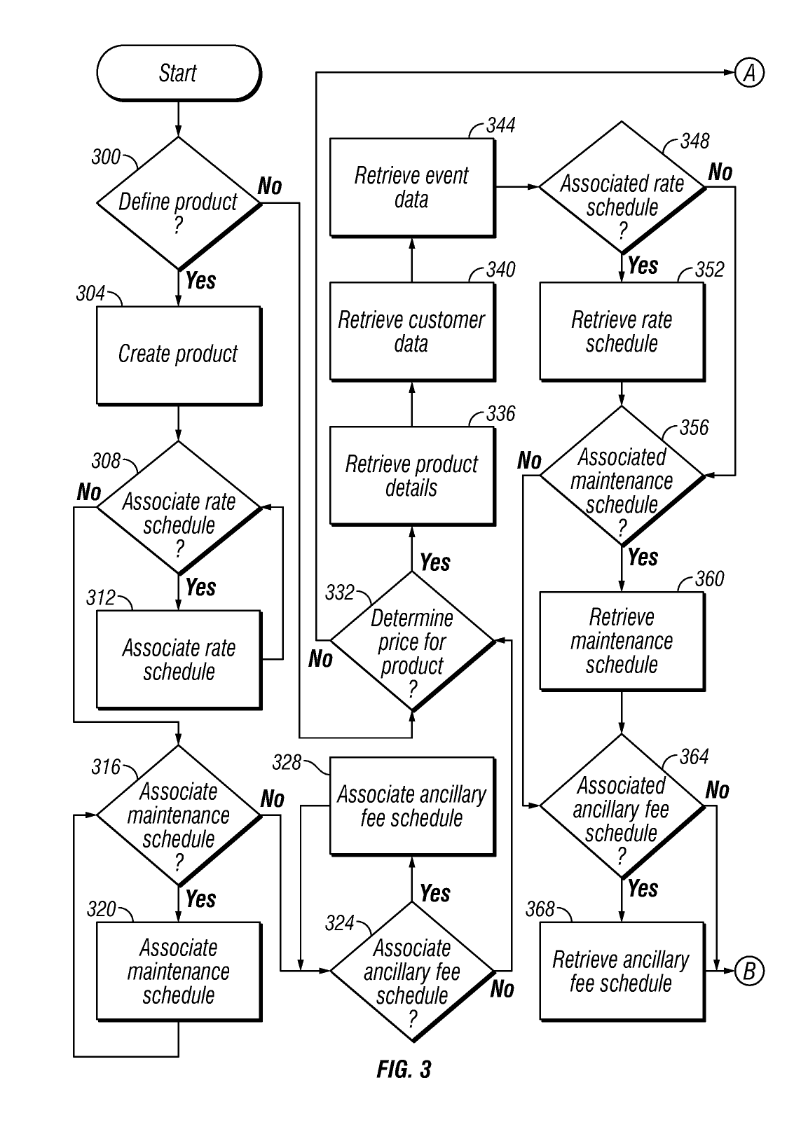

FIG. 2A illustrates example product data which may be used by the example system of FIG. 1. The example dataset of FIG. 2A is product information 200. Product information 200 is information that may be used by product management server 130 to provide various functionality to product deployment and management system 100. In certain embodiments, product information 200 may be stored as part of products 148.

It should be understood that product information 200 is provided for example purposes only. Product information 200 is depicted as having a tabular structure for illustrative purposes only. Product information 200 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Product deployment and management system 100 is capable of handling data in any suitable format, volume structure, and/or relationship as appropriate.

In the illustrated example, records 202 are example entries of product information 200 where each record 202 may correspond to a particular product 148. Product information 200 may contain product identifier 210, product name 220, and/or any other suitable information. In certain embodiments, product identifier 210 references a particular product 148. Product identifier 210 may be a number, text string, or any other identifier capable of identifying a particular product 148. In the current example, records 202a, 202b, and 202c contain product identifier 210 of “1,” “2,” and “3,” respectively, which may reference different products 148.

Product name 220 may represent the name of a particular product 148. For example, record 202a may be associated with a particular product 148 having a product name 220 of “Credit Card.” Record 202b may be associated with a product 148 having product name 220 of “Safe Deposit Box.” Record 202c may be associated with a product 148 having a product name 220 of “Checking”

FIG. 2B illustrates example fee schedule data which may be used by the example system of FIG. 1. The example dataset of FIG. 2B is fee schedule information 230. Fee schedule information 230 is information that may be used by product management server 130 to provide various functionality to product deployment and management system 100. In certain embodiments, fee schedule information 230 may be stored as part of fee schedules 150.

It should be understood that fee schedule information 230 is provided for example purposes only. Fee schedule information 230 is depicted as having a tabular structure for illustrative purposes only. Fee schedule information 230 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Product deployment and management system 100 is capable of handling data in any suitable format, volume structure, and/or relationship as appropriate.

In the illustrated example, records 232 are example entries of fee schedule information 230 where each record 232 may correspond to a particular fee schedule 150. Fee schedule information 230 may contain schedule identifier 234, schedule name 236, schedule type 238, and schedule details 240. In certain embodiments, schedule identifier 234 references a particular fee schedule 150 such as a rate schedule 156, maintenance fee schedule 158, or ancillary fee schedule 160. Schedule identifier 134 may be a number, text string, or any other identifier capable of identifying a particular fee schedule 150. Schedule name 236 may represent the name of a fee schedule 150. Fee schedule information 230 may also include schedule type 238. Schedule type 238 may reference a type of fee schedule 150. For example, schedule type 238 may reference rate schedule 156, maintenance fee schedule 158, or ancillary fee schedule 160. Schedule information 230 may also include schedule details 240. Schedule details 240 may include details for calculating charges, fees, credits, interests, or any other information related to a particular product 148. Schedule details 240 may also include conditional rules for when a particular schedule 150 may be applied to a product 148.

In the illustrated example, records 232 are all example entries in schedule information 230. Records 232a through 232f have corresponding schedule identifiers 234 of 1 through 6, respectively, signifying that they identify different fee schedules 150. Records 232a and 232b both have a corresponding schedule type 238 of rate, which may signify that records 232a and 232b define particular rate schedules 156. Record 232a corresponds to a fee schedule 150 having schedule name 236 of “New York City Rate,” which may indicate that this particular fee schedule 150 may only be applicable to a customer 102 with associated customer data 144 indicating that customer 102 lives in New York City. Record 232a has corresponding schedule details 240 of “2%.” Record 232a may represent a fee schedule 150 that gives a rate such as an interest rate or a loan rate, for example, of 2% to a customer 102 that may reside in New York City.

Record 232b may represent a particular fee schedule 150 having schedule name 236 of “Rural New York Rate.” Record 232b has corresponding schedule details 240 of “1.8%.” Record 232b may represent a particular fee schedule 150 with a rate of 1.8% for a customer that may reside in rural New York.

Record 232c and record 232d both have an associated schedule type 238 of maintenance, which may indicate that they are of type maintenance fee schedule 158. Record 232c has a schedule name of 236 of “Standard Charge” and associated schedule details 240 of “$5 per month.” Record 232c may indicate, for example, a maintenance fee schedule 158 that may be a “default” or “base” charge of $5.00 per month. Record 232d has a schedule name 236 of “Preferred Charge” with associated schedule details 240 of “$2 per month.” Record 232d may correspond to a maintenance fee schedule 158 indicating that certain preferred customers may receive a maintenance fee schedule 158 of $2.00 per month.

Records 232e and 232f have the schedule type 238 of ancillary fee, which may correspond to ancillary fee schedules 160. Record 232e has a schedule name 236 of “Preferred Channel” and schedule details 240 of “$0.” Record 232e may represent an ancillary fee 160 for a preferred channel (e.g., online) with a corresponding charge of $0. Record 232f has a corresponding schedule name 236 of “Standard Channel” with corresponding schedule details 240 of “$2,” which may correspond to an ancillary fee schedule 160 which is applicable as a default ancillary fee of $2.00.

FIG. 2C illustrates example contract data which may be used by the example system of FIG. 1. The example dataset of FIG. 2C is contracts information 250. Contracts information 250 is information that may be used by product management server 130 to provide various functionality to product deployment and management system 100. In certain embodiments, contracts information 250 may be stored as part of contracts 152.

It should be understood that contracts information 250 is provided for example purposes only. Contracts information 250 is depicted as having a tabular structure for illustrative purposes only. Contracts information 250 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Product deployment and management system 100 is capable of handling data in any suitable format, volume structure, and/or relationship as appropriate.

In the illustrated example, records 252 are example entries of contracts information 250 where each record 252 may correspond to a particular contract 152. Contract information 250 may contain contract identifier 254, customer 256, product identifier 258, rate 260, maintenance 262, and ancillary fee 264. In certain embodiments, contract identifier 254 references a particular contract 152. Contract identifier 254 may be a number, text string, or any other identifier capable of identifying a particular contract 152. In the current example, records 252a, 252b, and 252c contain contract identifier 254 of “1,” “2,” and “3,” respectively, which may reference different contracts 152.

Customer 256 may represent the name or reference to a particular customer 102. In certain embodiments, customer 256 may reference a particular entry in customer data 144 associated with a particular customer 102. Customer 256 may be a number, text string, or any other identifier capable of identifying a particular customer 102. In the illustrated example, record 252a is associated with a customer 256 referred to as “Customer1” which may represent a first customer 102. Record 252b includes customer 256 of “Customer1” which may also reference the first customer 102. Record 252c includes customer 256 of “Customer2” which may reference a second customer 102.

Contracts information 250 may also include product identifier 258. In certain embodiments, product identifier 258 may reference a particular product 148. Product identifier 258 may be any number, text string, or any other identifier capable of identifying a particular product 148. In the illustrated example, record 252a is associated with a product 148 corresponding to product identifier 258 of “2.” Records 252b and 252c are associated with a product 148 having a product identifier 258 of “3.” Contract information 250 may also include rate 260. In certain embodiments, rate 260 may reference a particular fee schedule 150 of the type rate schedule 156. In the illustrated example, record 252a has rate 260 of “n/a” indicating that there may not be a fee schedule 150 of type rate schedule 156 associated with a product 148 having product identifier 258 of 2. Record 252b has a rate 260 of “1,” which may correspond to a particular fee schedule 150 of type rate schedule 156. For example, rate 260 of 1 may reference record 232a of FIG. 2B with schedule identifier 234 of 1. Record 252c has rate 260 of “2,” which may be, as an example, a reference to record 232b of FIG. 2B with schedule identifier 232 of 2.

Contract information 250 may also include maintenance 262. Maintenance 262 may reference a particular fee schedule 150 having a fee schedule type of maintenance fee schedule 158. In the illustrated example, records 252a and 252b represent contracts 152 having a maintenance 262 of “3.” For example, maintenance 262 of 3 may reference record 232c of FIG. 2B having a schedule identifier 234 of 3. Record 252c may represent a contract 152 associated with maintenance 262 of “4” which may, for example, reference record 232d of FIG. 2B with a schedule identifier 234 of 4.

Contract information 250 may also include ancillary fee 264. Ancillary fee 264 may reference a particular fee schedule 150 having a type of ancillary fee schedule 160. In the illustrated example, record 252a represents a contract 152 having ancillary fee 264 of “n/a” indicating that there may not be an ancillary fee schedule 160 associated with the particular contract 152. Record 252b represents a contract 152 associated with ancillary fee 264 of “6.” Ancillary fee 264 of 6 may reference, for example, record 232f of FIG. 2B with schedule identifier 234 of 6. Record 252c represents a contract 152 having an ancillary fee 264 of “5” which may reference, for example, record 232e of FIG. 2B with schedule identifier 234 of 5.

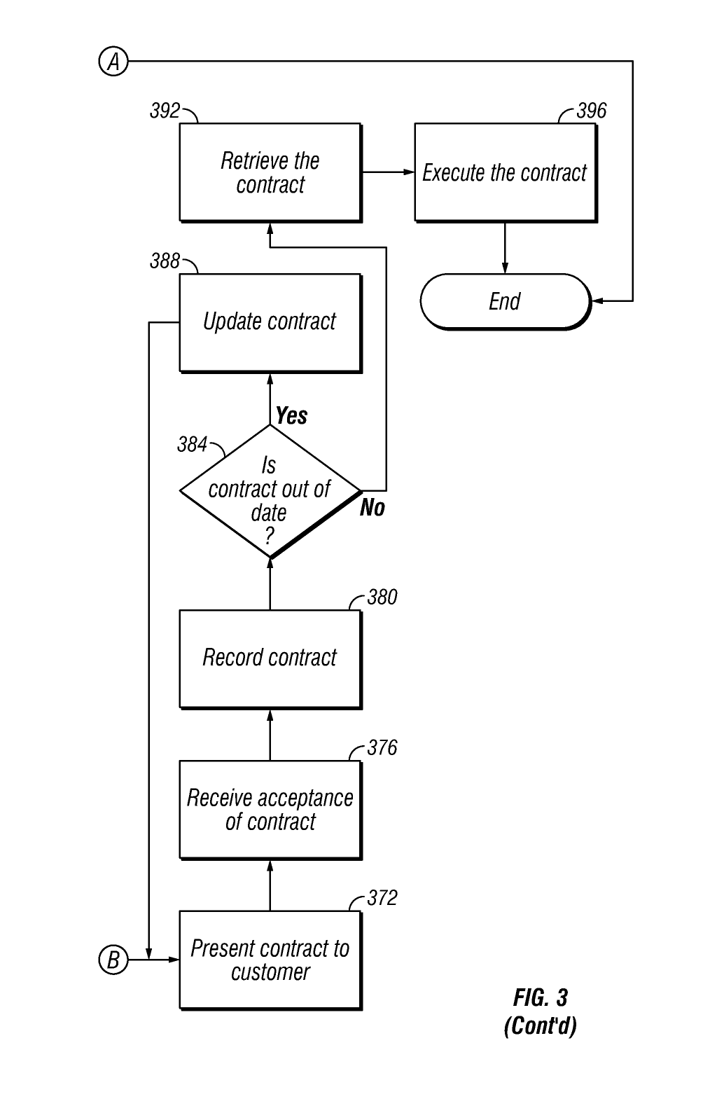

FIG. 3 illustrates an example method for product deployment and management, which may be performed by the example system of FIG. 1 according to certain embodiments of the present disclosure. The method may be implemented in any suitable combination of software, firmware, and hardware. Although particular components may be identified as performing particular steps, the present disclosure contemplates any suitable components performing the steps according to a particular purpose.

At step 300, an enterprise may decide whether or not to define a particular product 148. If a product 148 will not be defined, the example method may proceed to step 332. Otherwise, the example method may proceed to step 304. At step 304, product management server 130 may be utilized to define a particular product 148. More specifically, definition module 136 of product management server 130 can be used to define one or more products 148. For example, definition module 136 may be used to create a particular product 148. Creating a particular product 148 may include defining various details associated with a particular product 148 such as assigning a product identifier, a product name, and any other suitable details associated with product 148. After product 148 is created, the example method may proceed to step 308.

At step 308, it may be determined whether any rate schedules 156 may be associated with the particular product 148. If it is determined to associate a rate schedule 156 with the particular product 148, then the example method may proceed to step 312. Otherwise, the example method may proceed to step 316.

At step 312, definition module 136 may be used to associate one or more rate schedules 156 with a particular product 148. In certain embodiments, a rate schedule 156 may be associated with product 148 based on particular customer data 144, particular event data 146, or any other information that may affect a price of a product 148. Associated rate schedules 156 may be stored as part of products 148, contracts 152, fee schedules 150, or in any other component of product management server 130 suitable for a particular purpose. After associating a rate schedule 156 with the particular product 148, the example method may proceed to step 308.

It may be determined, at step 316, whether any maintenance fee schedules 158 may be associated with the particular product 148. If it is determined to associate a maintenance fee schedule 158 with the particular product 148, then the example method may proceed to step 320. Otherwise, the example method may proceed to step 324.

At step 320, definition module 136 may be used to associate one or more maintenance fee schedules 158 with a particular product 148. In certain embodiments, a maintenance fee schedule 158 may be associated with product 148 based on particular customer data 144, particular event data 146, or any other information that may affect a price of a product 148. Associated maintenance fee schedules 158 may be stored as part of products 148, contracts 152, fee schedules 150, or in any other component of product management server 130 suitable for a particular purpose. After associating a maintenance fee schedule 158 with the particular product 148, the example method may proceed to step 316.

At step 324, it may be determined whether any ancillary fee schedules 160 may be associated with the particular product 148. If it is determined to associate an ancillary fee schedule 160 with the particular product 148, then the example method may proceed to step 328. Otherwise, the example method may proceed to step 332.

Definition module 136, at step 328, may be used to associate one or more ancillary fee schedules 160 with the particular product 148. In certain embodiments, an ancillary fee schedule 160 may be associated with product 148 based on particular customer data 144, particular event data 146, or any other information that may affect a price of a product 148. Associated ancillary fee schedules 160 may be stored as part of products 148, contracts 152, fee schedules 150, or in any other component of product management server 130 suitable for a particular purpose. After associating an ancillary fee schedule 160 with the particular product 148, the example method may proceed to step 324.

After products 148 are defined, product deployment and management system 100 may determine a price for a particular product 148. At step 332, it may be decided whether a price for a particular product 148 may be determined. If the price for a particular product 148 is to be determined, the example method may proceed to step 336. Otherwise the example method may end.

At step 336, product deployment and management system 100 may determine a price for a product 148 by utilizing determination module 138. Determination module 138 may determine the price of a product 148 by accessing information from products 148. Next, at step 340, determination module 138 may retrieve customer data 144 for a particular customer 102 and the example method may proceed to step 344. At step 344, applicable event data 146, if any, may be retrieved by determination module 138 and the example method may proceed to step 348.

At step 348, determination module 138 may determine if there are any rate schedules 156 associated with the particular product 148. For example, determination module 138 may query fee schedules 150 for this determination. If one or more rate schedules 156 are associated with the particular product 148, the example method may proceed to step 352. Otherwise, the example method may proceed to 356.

Once determination module 138 has determined that there may be one or more rate schedules 156 associated with product 148, at step 352, determination module 138 may utilize customer data 144, event data 146, or any other information associated with customer 102 to retrieve the appropriate rate schedule 156 for the particular product 148. The example method may proceed to step 356.

At step 356, determination module 138 may determine if there are any maintenance fee schedules 158 associated with the particular product 148. For example, determination module 138 may query fee schedules 150 for this determination. If one or more maintenance fee schedules 158 are associated with the particular product 148, the example method may proceed to step 360. Otherwise, the example method may proceed to 364.

After determination module 138 has determined that there may be one or more maintenance fee schedules 158 associated with product 148, at step 360, determination module 138 may utilize customer data 144, event data 146, or any other information associated with customer 102 to retrieve the appropriate maintenance fee schedule 158 for the particular product 148. The example method may proceed to step 360.

At step 364, determination module 138 may determine if there are any ancillary fee schedules 160 associated with the particular product 148. For example, determination module 138 may query fee schedules 150 for this determination. If one or more ancillary fee schedules 160 are associated with the particular product 148, the example method may proceed to step 368. Otherwise, the example method may proceed to 372.

After determining that there may be one or more ancillary fee schedules 160 associated with product 148, at step 368, determination module 138 may utilize customer data 144, event data 146, or any other information associated with customer 102 to retrieve the appropriate ancillary fee schedule 160 for the particular product 148.

At step 372, determination module 138 may use all relevant accessed data to determine an appropriate price for the particular product 148 and product management server 130 may present that price to customer 102. For example, product management server 130 may communicate message 154 over network 120 to computer 110. Message 154 may comprise details about products 148, the determined price for the particular product 148, or any other information suitable for presenting a particular product 148 for sale to customer 102. In response to receiving message 154, computer 110 may present the quoted price of a particular product 148 to customer 102. Computer 110 may do this by presenting the price and/or details associated with the product 148 in GUI 116 of computer 110. The example method may then proceed to step 376.

In response to being presented a price quote for a particular product 148, customer 102, at step 376, may accept the presented price quote for a particular product 148. Customer 102 may indicate acceptance of the price quote for product 148 by interacting with computer 110. In response to customer 102 indicating to computer 110 that the quoted price for product 148 is accepted, computer 110 may communicate message 154 over network 120 to product management server 130. Message 154 may include an indication that customer 102 has accepted the quoted price for a particular product 148. The example method may proceed to step 380.

After customer 102 has indicated acceptance of a quoted price, record module 140, at step 380, may store details for an accepted offer for sale in contracts 152. Record module 140 may store any information associated with an accepted offer for sale for a particular product 148 by a customer 102 in contracts 152. Record module 140 may store in contracts 152 information associated with an accepted offer for sale such as a contract identifier, information associated with customer 102, information associated with a particular product 148, information associated with one or more fee schedules 150, such as rate schedule 156, maintenance fee schedule 158, and/or ancillary fee schedule 160 or any other information that may be associated with a particular accepted offer for sale. The example method may proceed to step 384.

At step 384, record module 140 may determine whether any contract 152 is out of date. For example, a change in customer data 144, event data 146, products 148 and/or fee schedules 150 may cause a price for an accepted offer for sale to change. If it is determined that the contract is not out of date, the example method may proceed to step 392. Otherwise, the example method may proceed to step 388.

In response to record module 140 determining that contract 152 may be updated, product management server 130 may facilitate, at step 388, the updating of the terms and conditions associated with a particular contract 152. Updating the terms and conditions associated with a particular contract may done utilizing the functionality of determination module 138. After updating terms and conditions associated with a particular contract 152, product management server 130 may facilitate the communication of an updated offer as the example method returns to step 372.

At step 392, when it is time for a particular contract 152 to be executed (e.g., on a specific date or after a certain period of time), execution module 142 may retrieve information stored in contracts 152, fee schedules 150, products 148, event data 146, customer data 144, and/or any other suitable information. The example method may proceed to step 396 where, in response to determining that a price for a particular contract 152 should not be adjusted or already has been adjusted, execution module 142 may make the determination that contract 152 should be executed and executes the particular contract 152.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as falling within the spirit and scope of the appended claims.

What is claimed is:

1. A system comprising:
a definition module, executed by a processor, operable to:
create a product definition associated with a product;
associate a first schedule with the product definition; and
associate a second schedule with the product definition;
a determination module, executed by the processor, operable to:
retrieve customer information associated with a customer;
determine a first possible price based at least in part upon the first schedule and the customer information;
determine a second possible price based at least in part upon the second schedule and the customer information;
compare the first possible price to the second possible price;
determine a first price for the product based at least in part on the result of the comparison; and
present the first price to a customer;
a record module, executed by the processor, operable to:
receive an indication that the customer has accepted the first price; and
associate the first price with the customer in response to receiving the indication; and
an execution module, executed by the processor, operable to:
retrieve event information associated with the customer;
determine a charge associated with the customer based at least in part upon the event information; and
initiate the billing of the customer for the charge.

2. A system comprising:
a memory; and
a processor communicatively coupled to the memory, the processor operable to:
create a product definition associated with a product;
associate a first schedule with the product definition; and
associate a second schedule with the product definition;
determine a first price for the product; and
present the first price to a customer;
receive an indication that the customer has accepted the first price; and
associate the first price with the customer in response to receiving the indication;
determine a charge associated with the customer; and
initiate the billing of the customer for the charge.

3. The system of claim 2, wherein the first schedule is a selected one of a group of schedule types, the group consisting of:
a rate schedule;
a maintenance fee schedule; or
an ancillary fee schedule.

4. The system of claim 2, wherein the first schedule and the second schedule are of the same schedule type.

5. The system of claim 2, wherein the processor is further operable to:
retrieve the product definition;
retrieve the first schedule;
retrieve the second schedule;
retrieve customer information associated with the customer; and
retrieve event information associated with the customer.

6. The system of claim 5, wherein determining the first price for the product comprises:
determining a first possible price based at least in part upon the first schedule;
determining a second possible price based at least in part upon the second schedule; and
selecting the first possible price as the first price for the product.

7. The system of claim 6, wherein the first possible price is further based at least in part upon the customer information.

8. The system of claim 6, wherein the first possible price is further based at least in part upon the event information.

9. The system of claim 6, wherein selecting the first possible price comprises comparing the first possible price to the second possible price.

10. The system of claim 6, wherein selecting the first possible price comprises comparing the first schedule to the second schedule.

11. The system of claim 2, wherein the processor is further operable to:
determine that the first price is inaccurate;
determine a second price for the product; and
present the second price to the customer.

12. A computer-implemented method comprising:
creating, using a processor, a product definition associated with a product;
associating, using the processor, a first schedule with the product definition;
associating, using the processor, a second schedule with the product definition;
determining, using the processor, a first price for the product;
presenting, using electronic communication, the first price to a customer;
receiving, at a network interface, an indication that the customer has accepted the first price;
associating, using the processor, the first price with the customer in response to receiving the indication;
determining, using the processor, a charge associated with the customer; and
initiating, using the processor, the billing of the customer for the charge.

13. The method of claim 12, wherein the first schedule is a selected one of a group of schedule types, the group consisting of:
a rate schedule;
a maintenance fee schedule; or
an ancillary fee schedule.

14. The method of claim 12, wherein the first schedule and the second schedule are of the same schedule type.

15. The method of claim 12, further comprising:
retrieving the product definition;
retrieving the first schedule;
retrieving the second schedule;
retrieving customer information associated with the customer; and
retrieving event information associated with the customer.

16. The method of claim 15, wherein determining the first price for the product comprises:
determining a first possible price based at least in part upon the first schedule;
determining a second possible price based at least in part upon the second schedule; and
selecting the first possible price as the first price for the product.

17. The method of claim 16, wherein the first possible price is further based at least in part upon the customer information.

18. The method of claim 16, wherein the first possible price is further based at least in part upon the event information.

19. The method of claim 16, wherein selecting the first possible price comprises comparing the first possible price to the second possible price.

20. The method of claim 16, wherein selecting the first possible price comprises comparing the first schedule to the second schedule.

21. The method of claim 12, further comprising:
determining that the first price is inaccurate;
determining a second price for the product; and
presenting the second price to the customer.
